(19) United States
(12) Patent Application Publication
(10) Pub. No.: US 2019/0208032 A1
(43) Pub. Date: Jul. 4, 2019

(54) SUBSCRIPTION ACKNOWLEDGMENTS

(71) Applicant: General Electric Company, Schenectady, NY (US)

(72) Inventors: Venkatesh SIVASUBRAMANIAN, San Ramon, CA (US); Sameer DEOKULE, San Ramon, CA (US); Danielle GAYDORUS, San Ramon, CA (US); Chandra KASIRAJU, San Ramon, CA (US)

(21) Appl. No.: 15/857,871

(22) Filed: Dec. 29, 2017

(51) Int. Cl. H04L 29/08; H04L 1/16

(52) U.S. Cl. CPC H04L 67/2842; H04L 1/1621; H04L 67/2809

(57) ABSTRACT

The example embodiments are directed to a system and method for managing the transfer of stream data to a subscriber system. In an example, the method includes one or more of receiving a data stream including messages that are published by a publisher system, transmitting a first plurality of messages from a partition of the data stream to a subscriber system while storing the first plurality of messages in chronological order in a first segment, receiving an acknowledgment of receipt of one or more of the first plurality of messages from the subscriber system, and in response to receiving a distinct acknowledgment of receipt of each respective message, transmitting a second plurality of messages from the partition of the data stream to the subscriber system and storing the second plurality of messages in linear order in a second segment.

### BACKGROUND

Machine and equipment assets are engineered to perform particular tasks as part of a process. For example, assets can include, among other things and without limitation, industrial manufacturing equipment on a production line, drilling equipment for use in mining operations, wind turbines that generate electricity on a wind farm, transportation vehicles, gas and oil refining equipment, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

Raw data that is sensed from an asset or about an asset may be transmitted to a central location such as a stream processing platform where it can be made available for consumption by applications and other devices. The stream processing platform provides a unified, high-throughput, low-latency platform that is able to handle significant amounts of real-time data feeds such as raw data from an asset. Its storage layer is essentially a scalable publish/subscribe message queue architected as a distributed transaction log making it highly valuable for processing streaming data. Within this architecture, consumers subscribe to topics of data provided from publishers.

However, the stream processing platform does not maintain an index that records what messages it has. As a result, consumers just specify offsets and the stream processing platform delivers the messages in order, starting with the offset. Furthermore, the stream processing platform does not provide individual message IDs. Instead, messages are simply addressed by their offset in the log. Furthermore, the stream processing platform does not track the consumers that a topic has or who has consumed what messages. All of that is left up to the consumers. Situations often arise where a consumer goes down or loses connection during a data transmission process with the stream processing platform resulting in a total loss of data transmitted during that session. When the consumer comes back online, the consumer typically requires the transmissions session to be restarted from the beginning of the transmission session because there is no way to track what amount of data has been received and/or processed by the consumer.

### SUMMARY

The example embodiments improve upon the prior art by providing a message broker in a publish/subscribe system (referred to herein as event hub) which transmits messages of a data stream in batches while storing the batches in a re-usable array of data segments. The message broker may transmit messages to the subscriber system while filling a first data segment with the transmitted message. When the first segment has been filled with messages, the message broker can pause message transmission to the subscriber until an acknowledgment has been received for each message among the batch of messages from the subscriber. As a result, a next batch of messages is only transmitted after a previous batch has been fully acknowledged. Further, acknowledgment holes can be prevented because out of order acknowledgments can be received and processed correctly because the message broker waits until all messages are acknowledged regardless of transmission order. Furthermore, the data segments used/filled-in with messages may be included within a re-usable a circular array of data segments that can be used repeatedly during the transmission of a data partition. As a result, data transfer can be performed by a smaller and faster memory device such as a cache.

According to an aspect of an example embodiment, a computing system includes one or more of a storage configured to store a data stream including messages that are published from a publisher system, and a processor configured to transmit a first plurality of messages from a partition of the data stream to a subscriber system and store the first plurality of messages in chronological order in a first segment configured to hold a portion but not all of the partition, wherein the processor may be further configured to receive an acknowledgment of receipt of one or more of the first plurality of messages from the subscriber system, and, in response to receiving a distinct acknowledgment of receipt of each respective message of the first plurality of messages of the first segment, transmit a second plurality of messages from the partition of the data stream to the subscriber system and store the second plurality of messages in linear order in a second segment.

According to an aspect of another example embodiment, a method includes one or more of receiving a data stream from a publishing system including messages that are published by the publisher system, transmitting a first plurality of messages from a partition of the data stream to a subscriber system while storing the first plurality of messages in chronological order in a first segment configured to hold a portion but not all of the partition, receiving an acknowledgment of receipt of one or more of the first plurality of messages from the subscriber system, and in response to receiving a distinct acknowledgment of receipt of each respective message of the first plurality of messages of the first segment, transmitting a second plurality of messages from the partition of the data stream to the subscriber system and storing the second plurality of messages in linear order in a second segment.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment for stream processing in accordance with an example embodiment.

FIG. 2 is a diagram illustrating an architecture of a topic of data from a streaming platform in accordance with an example embodiment.

FIG. 3 is a diagram illustrating a process 300 of re-using a circular array of segments for acknowledging transmission of stream data in accordance with example embodiments.

FIG. 4A is a diagram illustrating a bit array used for tracking subscription acknowledgments in accordance with an example embodiment.

FIG. 4B is a diagram illustrating a process of receiving acknowledgments in accordance with an example embodiments.

FIG. 5 is a diagram illustrating a method for managing the transfer of stream data in accordance with an example embodiment.

FIG. 6 is a diagram illustrating a computing system for managing the transfer of stream data in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a message broker (“event hub”) which can be used to deliver publisher data to one or more subscriber systems. The message broker can manage data transfer to and from a stream processing platform such as APACHE KAFKA®, however, embodiments are not limited thereto. The stream processing platform may store messages for publishing which may be transmitted from one or more processes or devices referred to as producers or publishers. The stream of data can be partitioned into different “partitions” within each topic of the data stream and the partitions may be arranged together within a partition map. Meanwhile, other processes and/or devices referred to as consumers can query messages from partitions. The stream processing platform can run on a cluster of one or more servers and the partitions can be distributed across cluster nodes.

In a related stream processing platform, an index of the records that have been transmitted is not maintained by the stream processing platform. Instead, consumers simply specify data offsets and the stream processing platform delivers the messages in order, starting with the offset. Furthermore, the stream processing platform does not provide individual message IDs. Instead, messages are simply addressed by their offset in the log. Because of this, a related stream processing platform is unable to track what data from a published topic has been consumed by a subscriber in the event that a connection is lost during data transfer. The message broker provided herein addresses these deficiencies and others by transmitting a data partition in batches of messages and waiting for each batch to be acknowledged prior to transmitting a next batch. To keep track of the messages that have been sent, the message broker stores a batch of messages in a data segment. Each segment may store a plurality of messages and may be included in a re-usable circular array of segments accessible to the event hub. The messages received from the publishing system may have a format/schema defined by the event hub herein. When all messages stored in a segment have been acknowledged by the subscriber system, the message broker can shift the cursor position to the next batch of messages, transmit the batch, and store the batch in a next segment of the re-usable circular array of segments. When the message broker runs out of segments, the message broker may flush a first segment in the array and re-use the segment for data transmission/acknowledgment.

The message broker described herein may perform adaptive redelivery of only those published messages from a segment which are not received while other messages from the segment are not re-transmitted. For example, the message broker may store/maintain a copy of each message within a segment and also a bit array in which each bit of the array is associated with a respective message from the segment. In this way, the message broker may signal that an acknowledgment has been received for a distinct message by changing a value of the bit indicator in the bit array for that particular message only. When all of the bit arrays have been changed, regardless of the order in which they are changed, the message broker determines that all of the messages stored in the segment have been received and moves to the next batch of messages. However, for any of the bits in the bit array that are not changed, the message broker may re-transmit only those messages corresponding to the unchanged bits. As a non-limiting example, if messages 1, 2, 5, and 6 stored in a data segment including six messages have been acknowledged by the subscriber system but messages 3 and 4 have not been acknowledge, the message broker may re-transmit only messages 3 and 4 by reading them from the data segment and re-sending.

In addition to adaptive redelivery, the example embodiments provide for prevention of acknowledgment holes which can plague stream processing platforms. Furthermore, the user of the circular array and segment re-use allows for faster memory (e.g., in-place caching) to be used during the data transfer process which is significantly faster than a streaming device using a hard disk or other data store and which also reduces the memory footprint regardless of payload and size of the data stream to be delivered to the subscriber system. In addition, acknowledgments may be provided individually by the subscriber, or they may be provided in batches thereby reducing transmissions. Whether all messages of a segment have been acknowledged is a process that is constantly monitored by the message broker thereby keeping the data transfer process running seamlessly. Segments may also have dynamic sizes based on various characteristics. The size of the segments may be dynamically set by a user via a configuration setting of the event hub. As another example, the size of the segments may be dynamically determined by the message broker in response to a condition such as a topic, a subscriber, a network connection, a bandwidth of the message broker, and the like.

The message broker and the stream processing platform may be incorporated within or otherwise used in conjunction with applications for managing machine and equipment assets and can be hosted within an Industrial Internet of Things (IIoT). For example, publishers may refer to assets or process associated with the assets, and subscribers may refer to applications and other machines that process and operate on data from the assets. In an example, an IIoT connects assets, such as turbines, jet engines, locomotives, elevators, healthcare devices, mining equipment, oil and gas refineries, and the like, to the Internet or cloud, or to each other in some meaningful way such as through one or more networks. The message broker can be implemented within a “cloud” or remote or distributed computing resource. The cloud can be used to receive, relay, transmit, store, analyze, or otherwise process information for or about assets and manufacturing sites. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

Integration of machine and equipment assets with the remote computing resources to enable the IIoT often presents technical challenges that are separate and distinct from the specific industry and from computer networks, generally. An asset may need to be configured with novel interfaces and communication protocols to send and receive data to and from distributed computing resources. Further, assets may have strict requirements for cost, weight, security, performance, signal interference, and the like. As a result, enabling such an integration is rarely as simple as combining the asset with a general-purpose computing systems.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial and/or healthcare based assets can be uniquely situated to leverage its understanding of assets themselves, models of such assets, and industrial operations or applications of such assets, to create new value for industrial customers through asset insights.

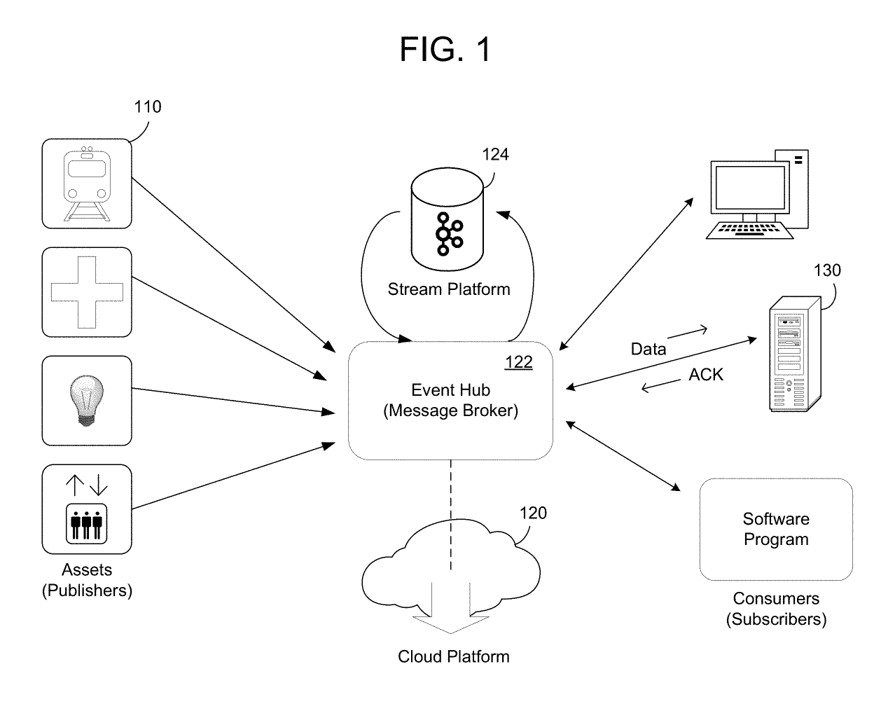

FIG. 1 illustrates a cloud computing environment 100 for stream processing in accordance with an example embodiment. Referring to FIG. 1, the cloud computing environment 100 includes a plurality of assets 110 which may be included within an IIoT and which may transmit/publish raw data (e.g., sensor data, etc.) to a source storage location such as stream platform 124 where it may be stored. The data stored at the stream platform 124 or passing through the stream platform 124 may be transferred to a target destination such as database one or more consumer device 130 (“subscribers”). The publisher systems 110 may include hardware such as assets, industrial computers, asset control systems, intervening industrial servers, and the like, which are coupled to or in communication with an asset. The publishers 110 may also include processes or software programs. The stream platform 124 may be included as part of a cloud platform 120, however, embodiments are not limited thereto. As another example, the stream platform 124 may be a remote database, a server, or the like, which is not stored in a cloud environment.

According to various embodiments, an event hub 122 may manage data transfer between the publishers 110, the stream platform 124, and the consumers 130. For example, event hub 122 may be a message broker service which is hosted by the cloud platform 120 and which interacts with the stream platform 124 to control data transfer. The event hub 122 may provide a bus or a logical interface at which publishers 110 can publish messages with data from data streams and the subscribers 130 can access the published message data to which they are subscribed. The subscribers 130 may include software applications such as analytics, user interfaces, visualization software, and the like. As another example, the subscribers 130 may include assets, devices, computing systems, and the like. As one example, a subscriber 130 may be a software application associated with a hardware asset publishing sensor data, however, embodiments are not limited thereto.

As further described herein, the event hub 122 may receive message objects from a publisher 110 and store the message data (i.e., data stream) at the stream platform 124. The stream platform 124 may store the published messages within one or more topics and each topic may include one or more partitions. The event hub 122 may receive a request or otherwise trigger a transfer of published data stored in the stream platform 124 to one or more subscribers 130. During the transfer, the event hub 122 may receive published message data and transmit partitions of the messages to a subscriber 130.

To perform the transfer, the event hub 122 may transmit a first batch of published messages (e.g., two messages, five messages, ten messages, twenty-five message, etc.) to a subscriber system and simultaneously store a copy of each message in a data segment maintained by the event hub 122. For example, the event hub 122 may continue transferring messages to the subscriber and simultaneously storing the transmitted messages in the data segment until the segment can no longer hold anymore messages (i.e., the segment is filled). At which point, the event hub can pause transmission to the subscriber and await acknowledgment of the first batch of messages. In other words, the event hub 122 may transmit the partition of data on a segment-by-segment basis to the subscriber 130. Before the event hub 122 moves the cursor to a next batch of messages of the data stream/data partition, the event hub 122 may wait to receive acknowledgments from the subscriber system 130 indicating that each distinct message that was stored in the segment has been received and processed by the subscriber 130.

In this example, an asset management platform (AMP) can reside in cloud computing platform 120 which may be included in a local or sandboxed environment, or can be distributed across multiple locations or devices and can be used to interact with the assets which may be publishers to the system. The AMP can be configured to perform functions such as data acquisition, data analysis, data exchange, and the like, with local or remote assets, or with other task-specific processing devices. For example, the assets may be an asset community (e.g., turbines, healthcare, power, industrial, manufacturing, mining, oil and gas, elevator, etc.) which may be communicatively coupled to the stream platform 124 via the cloud platform 120.

Information from the assets may be communicated to the stream platform 124 via the event hub 122. In an example, external sensors can be used to sense information about a function of an asset, or to sense information about an environment condition at or near an asset, a worker, a downtime, a machine or equipment maintenance, and the like. The external sensor can be configured for data communication with the stream platform 124 which can be configured to store the raw sensor information and transfer the raw sensor information over a network to the event hub 122 where it can be accessed by subscribers (e.g., users, applications, systems, and the like) for further processing. Furthermore, an operation of the assets may be enhanced or otherwise controlled by a user inputting commands though an application hosted by the cloud computing platform 120 or other remote host platform such as a web server or system coupled to the cloud platform 120. The data provided from the assets may include time-series data associated with the operations being performed. In order to transfer the data to the event hub 122 and the stream processing platform 124, the asset or asset system may assemble the data into message objects which have a schema that is defined by the event hub 122 and/or the stream platform 124.

The cloud platform 120 can also include services that developers can use to build or test industrial or manufacturing-based applications and services to implement IIoT applications that interact with output data from the slicing and merging software described herein. For example, the cloud platform 120 may host a microservices marketplace where developers can publish their distinct services and/or retrieve services from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Analytics (e.g., subscribers) are capable of analyzing data from or about a manufacturing process and provide insight, predictions, and early warning fault detection.

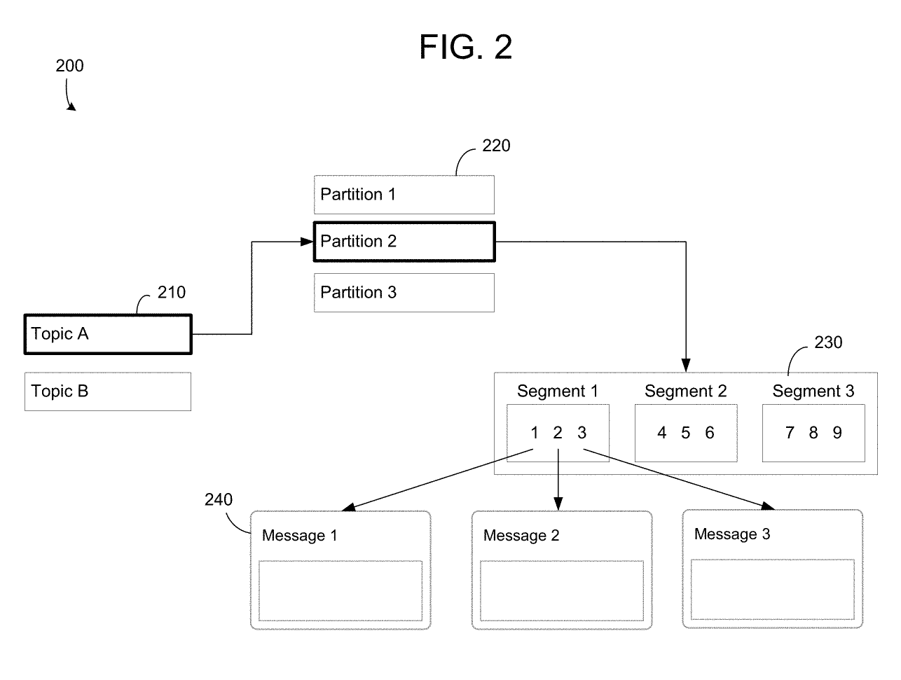

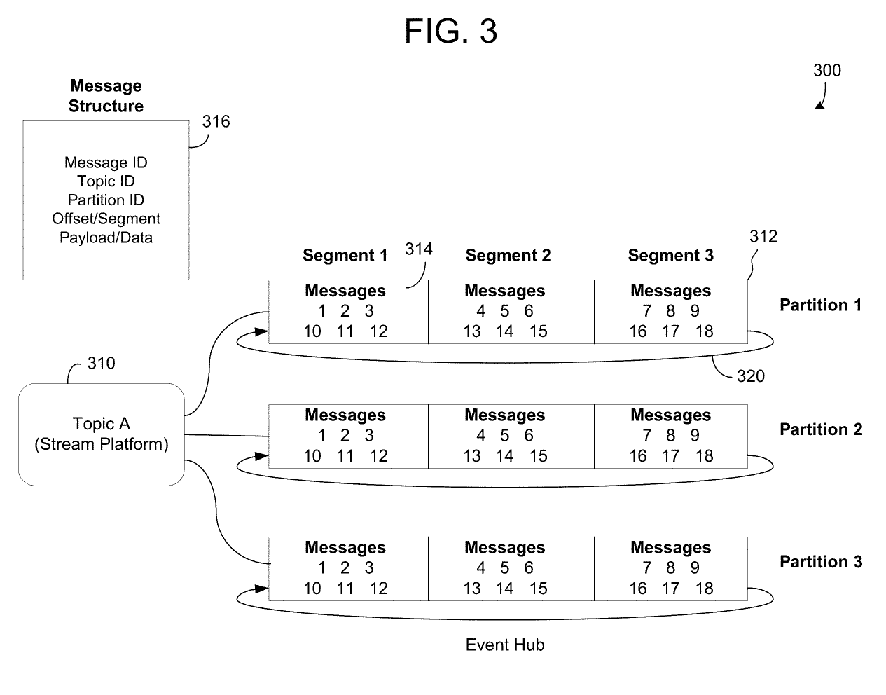

FIG. 2 illustrates an architecture 200 of a topic of data which may be stored by a streaming platform in accordance with an example embodiment, and FIG. 3 illustrates a process 300 of re-using a circular array of segments for acknowledging transmission of stream data in accordance with example embodiments. As a non-limiting example, the process 300 may be performed by the event hub 122 service executing on the cloud platform 120 shown in FIG. 1. Referring to FIG. 2, the data architecture 200 includes a plurality of topics (including topic 210) which are included in a data stream. Each topic refers to a named stream of records/messages which may be stored in logs by a stream processing platform and which may be subscribed to by a subscriber system. Furthermore, each topic may have its own respective subscribers or subscriber groups. A topic may refer to a stream name, data category, feed, or the like, such as a data feed from an asset. A stream processing platform may store a topic broken up into a plurality (or map) of partitions. The partitions may be spread across multiple servers or disks. Topics are typically broken into partitions for speed, scalability, and size.

A partition 220 from among the map of partitions included in the selected topic 210 is shown in the example of FIG. 2. Each partition may include an ordered immutable log sequence of messages/records which can be used as a structured commit log. Messages in partitions may be assigned sequential ID numbers referred to as offsets. The offset identifies a sequence of each message within a partition. According to various aspects, the partition 220 (including the ordered immutable record sequence) may be broken into a plurality of segments. For example, the event hub may transmit a first batch of messages 240 which includes three messages, and store the batch of messages 240 in a segment 230 from the immutable record sequence log of the partition 220. Each segment may have a static or fixed size of data. In other words, the number of messages that it takes to fill a segment can be dynamically adjusted. For example, a segment size may be adjusted based on a setting of the event hub 122 or a condition which automatically triggers a change or a modification in the size of the segment such as a subscriber, a publisher, a bandwidth, or the like.

In the example of FIG. 2, each segment stores messages in a linear order (i.e., chronological transmission order) of the messages 240. Each message corresponds to published data included in the partition 220. The message data includes a payload of the published data provided from a publisher such as time-series data, or the like. According to various embodiments, the event hub transmits a plurality of messages associated with a single segment and waits to receive acknowledgments of each message from among the plurality of messages before transmitting a plurality of messages associated with a next segment. As the messages are transmitted, they are stored in chronological order within a segment. This level of granularity generates an at-least once acknowledgment sequence in which the event hub determines whether all messages have been received. When all three messages 240 have been acknowledged by the subscriber system, the event hub may fill the next segment (i.e., segment 2) with the next batch of messages 4, 5, and 6, while simultaneously transmitting the next batch of messages to the subscriber system. This process may continue until the data partition 220 has been fully received and acknowledged by the subscriber. Furthermore, the segments can be re-used. For example, when the event hub has filled the last segment of the circular array of segments, the event hub may start over again with the first segment when transmitting a next batch of messages.

Referring to FIG. 3, the segments may be included in a circular array of segments which may be re-used during the data transmission process 300. In this example, a topic 310 includes at least three partitions of message data which are transmitted by the event hub to one or more subscriber systems. In the example of FIG. 3, a circular array of segments 312 includes three segment data blocks and is used to transmit 18 messages of data. In this example, the 18 data messages occupy six segment blocks. However, instead of using six segment blocks, the event hub can use less (e.g., three segment blocks) when keeping track of acknowledgments of batches of messages from the subscriber system by re-using segment blocks as shown in 320. In this way, the segments are an array of re-usable blocks that can be filled sequentially in a continuous loop. Accordingly, the circular array of segments 312 can maintain a fixed array or size regardless of a size of a partition of data to be submitted. In other words, when a partition includes more messages to be transmitted (e.g., 36 segments of data), the event hub may continue to use only three segment blocks by continually re-using the same three segments included in the circular array of segments 312.

According to various aspects, each segment may be filled with a plurality of messages 314 having a message structure 316. As an example, the message structure 316 may include a message ID which may be unique to a message in a respective segment, a topic ID, which may be common across all messages associated with a same topic, a partition ID which may be common across all message from a partition, a segment ID (offset) which may be common to the all messages within a segment, and a payload of data which is extracted from the partition. In the example of the message structure 316, each component of the message structure 316 may be shared with one or more other messages within a same partition and/or segment, however, none of the messages in the partition may have the exact same message structure 316.

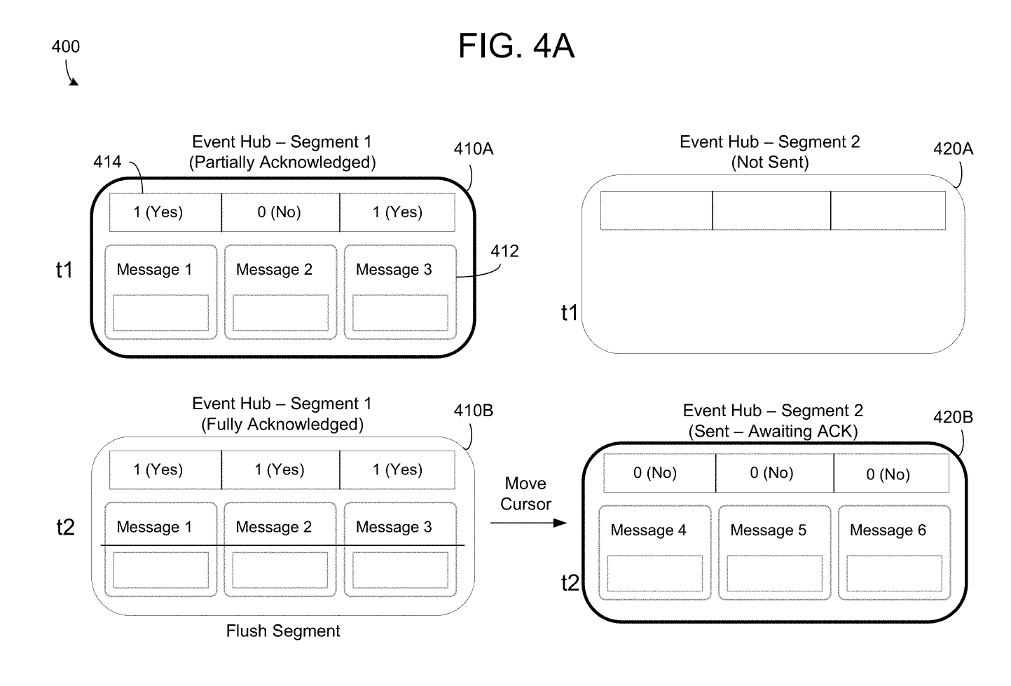

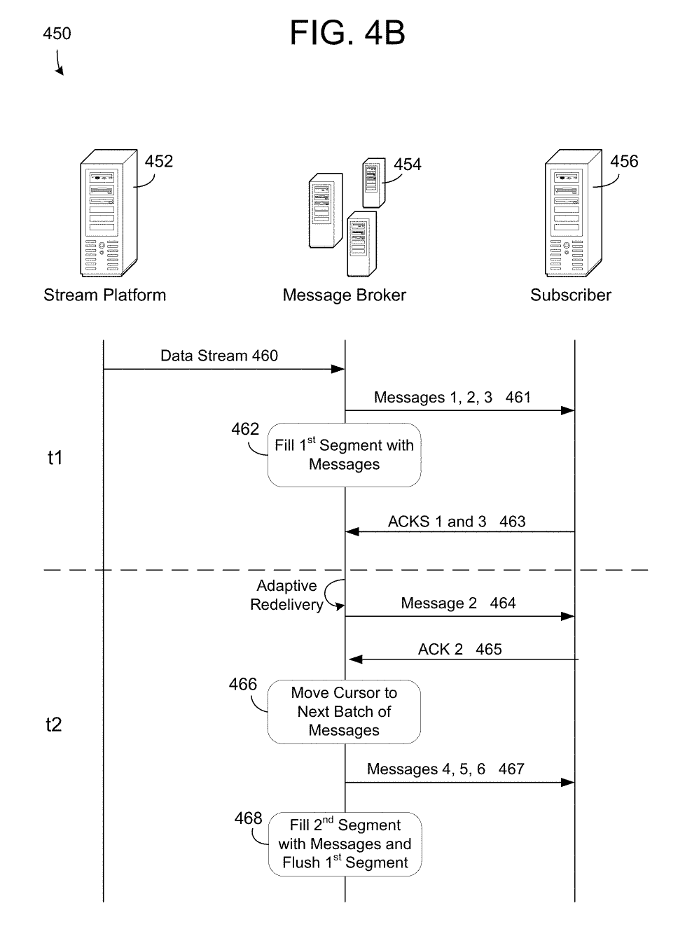

FIG. 4A illustrates a bit array used for tracking subscription acknowledgments in accordance with an example embodiment, and FIG. 4B illustrates a process 450 of receiving acknowledgments in accordance with an example embodiments. The bit arrays and the process 450 may be managed by the event hub 122 shown in FIG. 1, as an example. Referring to FIG. 4B, the process 450 is performed between a stream platform 452, a message broker 454, and a subscriber system 456. In 460, the stream platform 452 transmits a data stream to the message broker 454. Here, the data stream may include one or more partitions of data. In 461, the message broker 454 identifies a partition to be transmitted to the subscriber 456 and begins transmitting messages to the subscriber 456. The message broker 454 also fills in a first data segment in 462 with messages that are transmitted from the message broker 454 to the subscriber 456 until the first segment is filled with messages. In response, in 463 the message broker 454 receives acknowledgment of the first and third messages, but not the second message.

Referring to FIG. 4A, a first segment 410A corresponds to the first segment after the acknowledgments are received by the message broker 454, in 463 shown in FIG. 4B. Here, each of the messages 412 are stored in the segment 410A, and a bit array 414 is used to indicate whether an acknowledgment has been received. In this example, the bit array 414 indicates that an acknowledgment has been received for the first and the third messages, from among the plurality of messages 412. Meanwhile, a second segment 420A in the circular array of segments is empty.

Referring again to FIG. 4B, the message broker 454 determines to redeliver any messages that have not been specifically acknowledged by the subscriber system 456. In this example, the message broker 454 re-transmits the second message to the subscriber system, in 464, and receives an acknowledgment of receipt of the second message from the subscriber system, in 465. In response, the message broker 454 moves the cursor of the data partition to a next batch of messages, in 466, and begins transmitting a next batch of messages (i.e., messages 4, 5, and 6) to the subscriber system 456, in 467. The message broker 454 also fills a second segment with the second batch of messages and flushes the first segment. While the first segment is flushed at the same time as the second segment is being filled in this example, the embodiments are not limited thereto. Rather, the first segment can be flushed whenever the system determines to perform the memory flush such as when the first segment is need for re-used, or the like.

Referring to FIG. 4A again, first segment 410A corresponds to the first segment after the acknowledgment is received for the second message thereby receiving acknowledgment of all messages within the first segment. Here, the event hub may transmit the next batch of messages of the partition (i.e., fourth, fifth, and sixth messages) while storing the messages in the second segment 420B. The second segment 420B also includes a bit array which indicates that no acknowledgments have been received from the subscriber system. In addition, the event hub may flush the messages (i.e., first, second, and third messages) from the first segment in 410B.

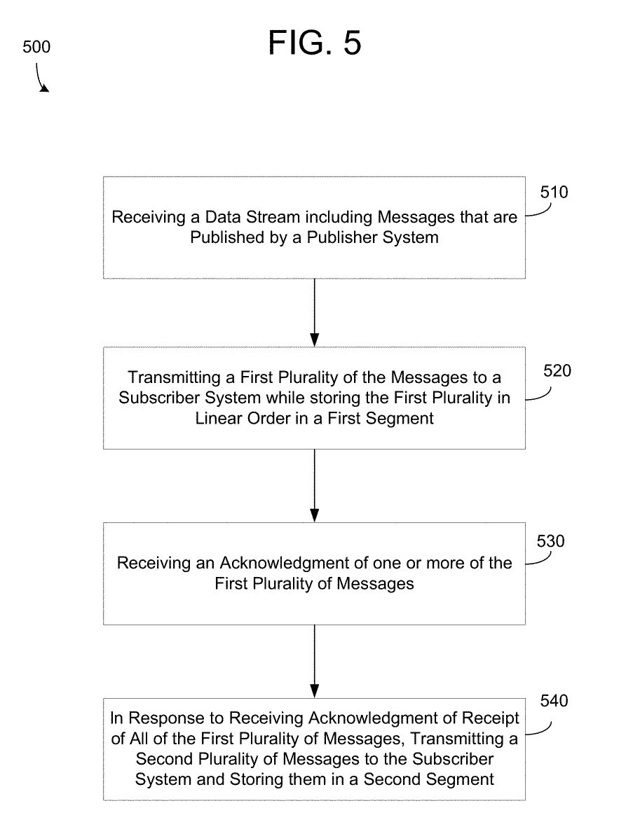

FIG. 5 illustrates a method 500 for managing the transfer of stream data from a stream processing platform to a subscriber system in accordance with an example embodiment. For example, the method 500 may be performed by a message broker or other service that is connected to a stream processing platform. In some examples, the message broker may be stored on a cloud platform, a server, a database, a stream processing platform, and the like. Referring to FIG. 5, in 510 the method includes receiving a data stream from a publishing system including messages that are published by the publisher system. Here, the data stream may include a block of data published using messages and which are stored in association with a in a stream platform. In some embodiments, the method may include receiving the data stream from a publisher computing system and storing the data stream in a stream processing database. For example, the method may be performed by the event hub message broker which communicates with the publisher, the stream processor platform, and the subscriber.

In 520, the method includes transmitting a first plurality of messages from a partition of the data stream to a subscriber system while storing the first plurality of messages in a chronological transmission order in a first segment. For example, the event hub may transmit the first plurality of messages until the first segment is filled and cannot hold any additional messages. The segment may be configured to hold a portion but not all of the partition. In addition to a published data payload, each message from among the first plurality of messages may include a unique combination of identifiers such as a unique combination of segment ID, message ID, topic ID, partition ID, and the like. The messages may be transmitted until the first segment has been filled or can no longer hold another message. The segment ID may be shared by all messages in the segment, the partition ID may be shared by all messages in the data stream partition, and the topic ID may be shared by all messages in the topic. As a result, some of the identifications may be shared, however, no message within the partition will include the same combination of identifications.

In 530, the method includes receiving a distinct acknowledgment for one or more of the first plurality of messages from the subscriber system. When a distinct acknowledgment is received for all of the first plurality of messages of the first segment, the event hub may move the cursor to the next segment of the partition. For example, in 540, the method may include transmitting a second plurality of messages from the partition of the data stream to the subscriber system and storing the second plurality of messages in chronological order in a second segment. In order to keep track of the acknowledgments, the method may further including storing a bit array for each segment which includes an acknowledgment bit for each message from among the plurality of messages of the respective segment. In this example, each acknowledgment bit may indicate with a ‘1’ or a ‘0’ whether or not an acknowledgment has been received for a respective message. As another example, the array may use a flag, a symbol, or the like, and is not limited to binary bits. When some but not all of the acknowledgments have been received from the subscriber system, the method may include re-transmitting only the messages of the first plurality of messages which have not been acknowledged by the subscriber system.

In some embodiments, the first and second segments may be part of a circular re-usable array of segments which can be re-used during the transmission of the partition. In this example, the method may further include flushing data stored in the first segment in response to receiving a distinct acknowledgment for each message of the first plurality of messages of the first segment, and re-using the first segment when transmitting another batch of messages of the partition to the subscriber system. Here, the first segment may be re-used after all remaining segments have been re-used thus completing the circle of arrays and beginning with the first segment, again. As another example, in some embodiments, the segmenting may include dynamically segmenting the partition into segments having a dynamically configurable size based on a modifiable configuration setting. The size of the segments may be adjusted based on a configuration setting within the event hub message broker which can be modified by an operator or automatically based on a type of data, a topic, a subscriber, a publisher, etc.

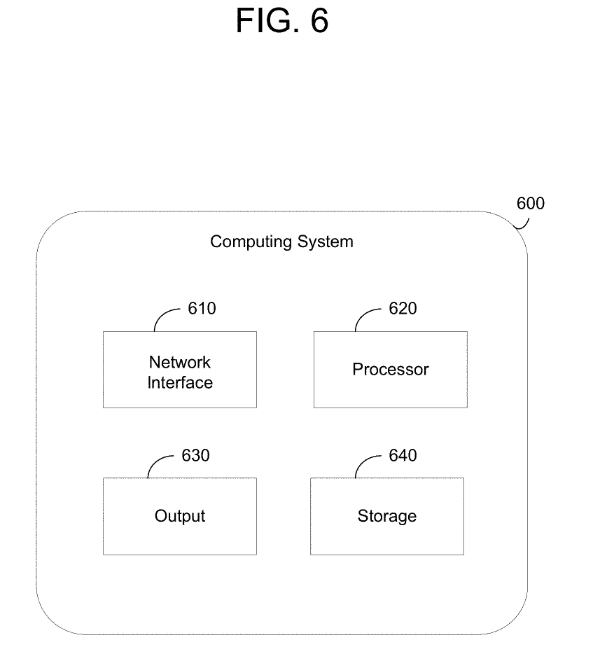

FIG. 6 illustrates a computing system 600 for managing the transfer of stream data from a stream processing platform to a subscriber system in accordance with an example embodiment. For example, the computing system 600 may be a database, an instance of a cloud platform, a streaming platform, and the like. In some embodiments, the computing system 600 may be distributed across multiple devices. Also, the computing system 600 may perform the method 500 of FIG. 5. Referring to FIG. 6, the computing system 600 includes a network interface 610, a processor 620, an output 630, and a storage device 640 such as a memory. Although not shown in FIG. 6, the computing system 600 may include other components such as a display, one or more input units, a receiver, a transmitter, and the like.

The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The output 630 may output data to an embedded display of the computing system 600, an externally connected display, a display connected to the cloud, another device, and the like. The output 630 may include a device such as a port, an interface, or the like, which is controlled by the processor 620. In some examples, the output 630 may be replaced by the processor 620. The storage device 640 is not limited to a particular storage device and may include any known memory device such as RAM, ROM, hard disk, and the like, and may or may not be included within the cloud environment. The storage 640 may store software modules or other instructions which can be executed by the processor 620.

According to various embodiments, the network interface 610 may receive a data stream from a publisher system and the processor 620 may store the received data stream within the storage 640. As another example, the data stream may be stored remotely in a stream processing platform or other remote device. The data stream may include messages transmitted by a publisher and associated with one or more topics which a subscriber system can subscribe to. Each topic may include one or more partitions of data. To transfer the published message data from the stream processing platform to the subscriber system, the processor 620 may to transmit a first plurality of messages from a partition of the data stream to a subscriber system and store the first plurality of messages in chronological order in a first segment configured to hold a portion but not all of the partition.

For example, the processor 620 may transmit messages from the partition until the first segment has filled, and then temporarily stop sending messages until acknowledgments are received for all of the segments included in the first segment. That is, the processor 620 may receive an acknowledgment of receipt of the first plurality of messages from the subscriber system. When a distinct acknowledgment of receipt of each respective message of the first plurality of messages of the first segment has been received, the processor 620 may continue transmitting messages (i.e., a second plurality of messages) from the partition of the data stream to the subscriber system and store the second plurality of messages in chronological order in a second segment. Each of the messages may have unique identification information which includes common segment and partition IDs, and distinct message IDs. The size of the segments may be static or they may be dynamically chosen, for example, automatically or based on a modifiable configuration setting within the event hub message broker.

The processor 620 may also receive (e.g., via the network interface 610) a distinct acknowledgment for one or more of the first plurality of messages from the subscriber system. According to various embodiments, in response to receiving a distinct acknowledgment for each respective message of the first plurality of messages of the first segment, the processor 620 may continue with a next batch of messages. However, if the processor 620 does not receive an acknowledgment of at least one message of the first plurality of messages, the processor 620 may re-transmit only the at least one message that was not acknowledged from among the first plurality of messages to the subscriber system and wait for acknowledgment before transmitting the second batch of messages.

The segments may be stored in a circular re-usable array of segments. Furthermore, the processor 620 may also generate and store a bit array for each segment which includes an acknowledgment bit for each message from among the plurality of messages in the segment. Here, each acknowledgment bit corresponds to a different message and indicates whether or not a distinct acknowledgment has been received for the respective message. In some embodiments, the processor 620 may flush data stored in the first segment in response to receiving a distinct acknowledgment for each message of the first plurality of messages of the first segment, and re-use the first segment when transmitting additional messages of the partition to the subscriber system. For example, when the circular array has been completely used, the processor 620 may begin using the first segment of the circular array of segments in a continuous cycle.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), a random-access memory (RAM) and/or any non-transitory transmitting/receiving medium such as the Internet, cloud storage, the Internet of Things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store a data stream from a publisher system; and
a processor configured to transmit a first plurality of messages from a partition of the data stream to a subscriber system and store the first plurality of messages in chronological order in a first segment configured to hold a portion but not all of the partition,
wherein the processor is further configured to receive an acknowledgment of receipt of one or more of the first plurality of messages from the subscriber system, and, in response to receiving a distinct acknowledgment of receipt of each respective message of the first plurality of messages of the first segment, transmit a second plurality of messages from the partition of the data stream to the subscriber system and store the second plurality of messages in linear order in a second segment.

2. The computing system of claim 1, wherein the processor is further configured to store a bit array for the first segment which includes an acknowledgment bit for each message from among the first plurality of messages, and each acknowledgment bit indicates whether or not a distinct acknowledgment has been received for a respective message.

3. The computing system of claim 1, wherein the first and second segments are included in a circular re-usable array of segments which the processor can re-use during the transmission of the partition.

4. The computing system of claim 1, wherein the processor is further configured to flush data stored in the first segment in response to receiving a distinct acknowledgment for each message of the first plurality of messages of the first segment, and re-use the first segment when transmitting another plurality of messages of the partition to the subscriber system.

5. The computing system of claim 1, further comprising a network interface configured to receive the data stream from a publisher system and the processor is further configured to store the received data stream in a stream processing database.

6. The computing system of claim 1, wherein the processor is configured to dynamically configure a size of the first segment based on a configuration setting.

7. The computing system of claim 1, wherein, in response to receiving an acknowledgment of at least one of message and not receiving an acknowledgment of at least one other message, of the first plurality of messages, the processor is configured to re-transmit only the at least one other messages of the first plurality of messages stored in the first segment to the subscriber system.

8. The computing system of claim 1, wherein each message from among the first plurality of messages comprises a data payload, a common segment identification, and a unique message identification.

9. A computer-implemented method comprising:
receiving a data stream published by a publisher system;
transmitting a first plurality of messages from a partition of the data stream to a subscriber system while storing the first plurality of messages in chronological order in a first segment configured to hold a portion but not all of the partition;
receiving an acknowledgment of receipt of one or more of the first plurality of messages from the subscriber system; and
in response to receiving a distinct acknowledgment of receipt of each respective message of the first plurality of messages of the first segment, transmitting a second plurality of messages from the partition of the data stream to the subscriber system and storing the second plurality of messages in linear order in a second segment.

10. The computer-implemented method of claim 9, further comprising storing a bit array for the first segment which includes an acknowledgment bit for each message from among the first plurality of messages, wherein each acknowledgment bit indicates whether or not a distinct acknowledgment has been received for a respective message.

11. The computer-implemented method of claim 9, wherein the first and second segments are included in a circular re-usable array of segments which can be re-used during the transmission of the partition.

12. The computer-implemented method of claim 9, further comprising flushing data stored in the first segment in response to receiving a distinct acknowledgment for each message of the first plurality of messages of the first segment, and re-using the first segment when transmitting another plurality of messages of the partition to the subscriber system.

13. The computer-implemented method of claim 9, further comprising receiving the data stream from a publisher computing system and storing the data stream in a stream processing database.

14. The computer-implemented method of claim 9, further comprising dynamically configuring a size of the first segment based on a configuration setting.

15. The computer-implemented method of claim 9, wherein, in response to receiving an acknowledgment of at least one of message and not receiving an acknowledgment of at least one other message, of the first plurality of messages, the method further comprises re-transmitting only the at least one other messages of the first plurality of messages stored in the first segment to the subscriber system.

16. The computer-implemented method of claim 9, wherein each message from among the first plurality of messages comprises a data payload, a common segment identification, and a unique message identification.

17. A non-transitory computer readable medium comprising program instructions that when executed are configured to cause a processor to execute a method comprising:
receiving a data stream published by a publisher system;
transmitting a first plurality of messages from a partition of the data stream to a subscriber system while storing the first plurality of messages in chronological order in a first segment configured to hold a portion but not all of the partition;
receiving an acknowledgment of receipt of one or more of the first plurality of messages from the subscriber system; and
in response to receiving a distinct acknowledgment of receipt of each respective message of the first plurality of messages of the first segment, transmitting a second plurality of messages from the partition of the data stream to the subscriber system and storing the second plurality of messages in linear order in a second segment.

18. The non-transitory computer readable medium of claim 17, wherein the method further comprises storing a bit array for the first segment which includes an acknowledgment bit for each message from among the first plurality of messages, and each acknowledgment bit indicates whether or not a distinct acknowledgment has been received for a respective message.

19. The non-transitory computer readable medium of claim 17, wherein the first and second segments are included in a circular re-usable array of segments which can be re-used during the transmission of the partition.

20. The non-transitory computer readable medium of claim 17, wherein the method further comprises flushing data stored in the first segment in response to receiving a distinct acknowledgment for each message of the first plurality of messages of the first segment, and re-using the first segment when transmitting another plurality of messages of the partition to the subscriber system.
